(19) United States
(12) Patent Application Publication
(10) Pub. No.: US 2023/0358085 A1
(43) Pub. Date: Nov. 9, 2023

(54) Secure Door Hinge Assembly for Security Compartment

(71) Applicant: Console Vault, LLC, Powell, OH (US)

(72) Inventors: Scott Bonvissuto, Westerville, OH (US); Christopher Cannizzaro, Hilliard, OH (US); Adam Dodson, CO Springs, CO (US); Christos Ragias, Westerville, OH (US)

(21) Appl. No.: 18/143,467

(22) Filed: May 4, 2023

Related U.S. Application Data
(60) Provisional application No. 63/338,408, filed on May 4, 2022.

(51) Int. Cl. E05C 3/00; E05C 3/02; E05D 3/02; E05D 5/06

(52) U.S. Cl. CPC E05D 5/062; E05C 3/004; E05C 3/02; E05D 3/02; E05B 83/32

(57) ABSTRACT

A door hinge assembly for securing access to a security compartment is disclosed in which the door is received within a recess of a door frame that is in turn fixed to a security compartment. The door rotates between closed and open positions by rotating about a pivot connection that is formed between the door and the door frame by a high security gooseneck. The gooseneck is fixed to the door and has a gooseneck channel formed of first and second wall portions and a lower portion connecting the two wall portions. One of the wall portions is connected to a pivot point beneath the door frame and the other to the connection portion connected to the door.

### CROSS-REFERENCE TO RELATED APPLICATIONS

This patent application claims the benefit of U.S. Provisional Pat. Application Serial No. 63/338,408 filed on 4 May 2022 and entitled Secure Door Hinge Assembly for Security Compartment, the disclosure of which is hereby incorporated by reference herein in its entirety and made part of the present U.S. utility patent application for all purposes.

### TECHNICAL FIELD

Embodiments generally relate to devices for securing valuable personal items which are concealed within a compartment.

### BACKGROUND OF THE INVENTION

Taking valuable personal items outside of your home includes a number of risks depending on the type of valuable that is being transported. When transporting valuable items, the user’s primary concern may be the theft of those items. When designing security enclosures/compartments for mobile applications (ex. vehicles, automobiles, trucks, and recreational vehicles) the design must be robust and resistant to prying or failure and simultaneously lightweight (heavy thick-walled steel is not preferred in these applications).

Current designs for the door assembly and hinges for secure enclosures/compartments do not have adequate prying resistance. In some cases the hinges are visible and/or vulnerable to prying. It is desirable to create a durable hinge design for a door assembly that is lightweight and resistant to tampering/prying.

### BRIEF SUMMARY OF THE INVENTION

The following provides a summary of certain example implementations of the disclosed technology. This summary is not an extensive overview and is not intended to identify key or critical aspects or elements of the disclosed technology or to delineate its scope. However, it is to be understood that the use of indefinite articles in the language used to describe and claim the disclosed technology is not intended in any way to limit the described technology. Rather the use of “a” or “an” should be interpreted to mean “at least one” or “one or more”.

Exemplary embodiments provide a door hinge assembly having a high security gooseneck that connects between the bottom side of the door and a bottom side of the door frame. The gooseneck is generally U-shaped and is connected at one end to the hinge with a spring that is biased for the door to be normally open. A recess sized for the perimeter geometry of the door is located on the door frame and is found beneath each portion of door gap such that there is no “daylight” into the compartment.

The foregoing and other features and advantages of the present invention will be apparent from the following more detailed description of the particular embodiments, as illustrated in the accompanying drawings.

One implementation of the disclosed technology provides a door hinge assembly for providing access to a security compartment, having a door frame, a door, and a high security gooseneck. The door frame has a top surface, a recess and an interior mounting portion whereby the door hinge assembly is secured to the security compartment. The door is shaped to be received within the recess of the door frame wherein a top surface of the door is coplanar with the top surface of the door frame. The gooseneck has a pivot connection whereby it is rotatable about the connection and connected to the door frame, a connecting portion whereby the gooseneck is fixed to the door, and a gooseneck channel connecting the pivot connection to the connecting portion.

In some embodiments, the gooseneck channel is made of a first wall portion connected to the connecting portion, a lower portion connected to the first wall portion at a first interior angle, and a second wall portion connected to the lower portion at a second interior angle.

In some implementations, the first and second interior angles are each substantially 90 degrees. In other implementations, the first interior angle and the second interior angle can each range between 60 and 120 degrees. In a preferred embodiment, the pivot connection is positioned below the door frame and within the security compartment when the door hinge assembly is secured to the compartment.

In some implementations, the door hinge assembly is provided with a latch positioned beneath and rotatable with respect to a bottom surface of the door, a front wall extending downwardly from the bottom surface of the door having a latch slot wherein the latch is rotatable to extend through the latch slot in the front wall in a locked position, and a latch channel secured to the door frame into which the front wall is received when the door is rotated about the pivot connection of the gooseneck into a closed position.

There are also disclosed implementations in which the latch channel is made of an upper portion secured to the door frame, a first vertical portion connected to the upper portion and having a first latch slot, a lower portion connected to the first vertical portion, and a second vertical portion connected to the lower portion and having a second latch slot, wherein the first and second vertical portions and lower portions form a channel into which the front wall of the door is received when the door is rotated about the pivot connection of the gooseneck into a closed position.

In some embodiments, the gooseneck is shaped to receive a portion of the door frame in the gooseneck channel when the door is rotated into an open position. Some of those implementations include a gooseneck having a connecting portion secured to the door, a first wall portion connected to the connecting portion, a lower portion connected to the first wall portion at a first interior angle, a second wall portion connected to the lower portion at a second interior angle, and a pivot connection connecting the second wall portion to the door frame whereby the gooseneck is rotatable about the pivot connection with respect to the door frame.

Some disclosed implementations include the interior mounting portion composed of at least one mounting tab extending downwardly from the door frame and at least one mounting aperture on the at least one mounting tab whereby the door frame is fixable to the security compartment.

In some embodiments the gooseneck also includes a first hinge barrel set having at least one hinge, wherein the first hinge barrel set is complementary to a second hinge barrel set having at least one hinge barrel on a hinge plate fixed to the door frame, and a hinge pin connecting the complementary sets of hinge barrels.

It should be appreciated that all combinations of the foregoing concepts and additional concepts discussed in greater detail below (provided such concepts are not mutually inconsistent) are contemplated as being part of the technology disclosed herein and may be implemented to achieve the benefits as described herein. Additional features and aspects of the disclosed system, devices, and methods will become apparent to those of ordinary skill in the art upon reading and understanding the following detailed description of the example implementations. As will be appreciated by the skilled artisan, further implementations are possible without departing from the scope and spirit of what is disclosed herein. Accordingly, the descriptions provided herein are to be regarded as illustrative and not restrictive in nature.

### BRIEF DESCRIPTION OF THE DRAWINGS

The accompanying drawings, which are incorporated into and form a part of the specification, schematically illustrate one or more example implementations of the disclosed technology and, together with the general description given above and detailed description given below, serve to explain the principles of the disclosed subject matter, and wherein:

FIG. 1 is a top perspective view of compartment including an exemplary embodiment of a door hinge assembly.

FIG. 2 is a top perspective view of the embodiment of FIG. 1 where an exemplary door hinge assembly has been removed from the compartment.

FIG. 3 is a top perspective view of an exemplary door hinge assembly where the door has been opened.

FIG. 4 is a bottom perspective view of an exemplary door hinge assembly.

FIG. 5 is a bottom plan view of an exemplary door hinge assembly.

FIG. 6 is a top plan view of an exemplary door hinge assembly and indicating the location of section line A-A.

FIG. 7 is a section view taken along section line A-A and indicating the locations of DETAIL A and DETAIL B.

FIG. 8 is a section view taken along section line A-A where the door has been opened.

FIG. 9 is a detailed section view of DETAIL A.

FIG. 10 is a detailed section view of DETAIL B.

FIG. 11 is a top perspective view of a first exemplary embodiment of the high security gooseneck.

FIG. 12 is a side elevation view of the high security gooseneck shown in FIG. 11.

FIG. 13 is a side elevation view of a second exemplary high security gooseneck embodiment.

FIG. 14 is a side elevation view of a third exemplary high security gooseneck embodiment.

FIG. 15 is a perspective view of a fourth exemplary high security gooseneck embodiment.

### DETAILED DESCRIPTION

Example implementations are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the disclosed technology. Accordingly, the following implementations are set forth without any loss of generality to, and without imposing limitations upon, the claimed subject matter.

The examples discussed herein are examples only and are provided to assist in the explanation of the apparatuses, devices, systems, and methods described herein. None of the features or components shown in the drawings or discussed below should be taken as required for any specific implementation of any of these the apparatuses, devices, systems or methods unless specifically designated as such. For ease of reading and clarity, certain components, modules, or methods may be described solely in connection with a specific Figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Similarly, the use of the word “or” is intended to be non-exclusive unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, or groups thereof.

Embodiments of the invention are described herein with reference to illustrations that are schematic illustrations of idealized embodiments (and intermediate structures) of the invention. As such, variations from the shapes of the illustrations as a result, for example, of manufacturing techniques or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

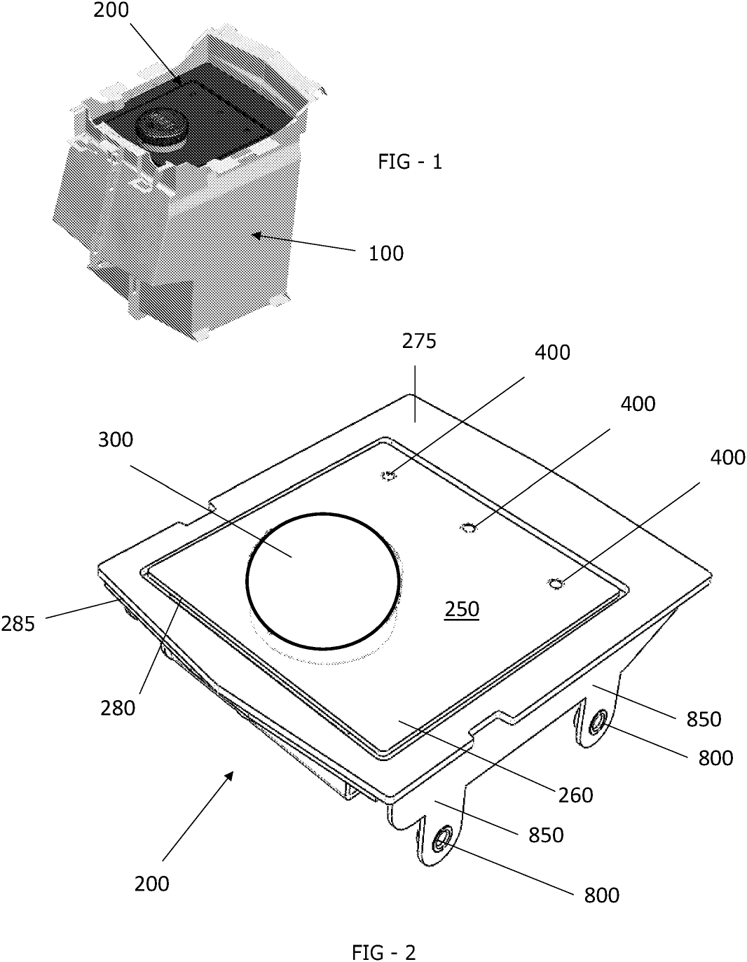

FIG. 1 is a top perspective view of an exemplary compartment 100 including an exemplary embodiment of a door hinge assembly 200.

FIG. 2 is a top perspective view of the exemplary door hinge assembly 200 of the embodiment of FIG. 1 shown in isolation from the compartment 100. The door hinge assembly 200 can be used with any shape of compartment, so it should be expressly appreciated that the shape of the compartment 100 shown in connection with FIG. 1 is only an example, as any shape of compartment could work with the exemplary embodiments herein.

The assembly 200 preferably includes a door 260 that is seated within a door frame 285. When the door 260 is closed (as shown in FIG. 2) the top surface 250 of the door 260 is preferably in the same plane as the top surface 275 of the door frame 285. In other words, the top surface 250 should be generally parallel to the top surface 275. The door gap 280 extends all around the door 260 and identifies the location where the top surface 250 of the door 260 meets the top surface 275 of the door frame 285.

One or more interior mounting portions 850 provide the means by which the door hinge assembly 200 is securely fastened to the compartment. In some embodiments, the interior mounting portion is provided as one or more interior mounting tabs 850 preferably extend downwardly from one or more sides of the door frame 285, and provide mounting apertures 800 for fasteners or rivets to engage with when securing the door hinge assembly 200 into a compartment (e.g., compartment 100 shown in FIG. 1). In a preferred embodiment at least one mounting tab 850 extends downwardly from opposing sides of the door frame 285. A lock assembly 300 allows access to the latch (not shown here) for locking the door 260 when it is in the closed position. In one embodiment, a plurality of threaded fasteners 400 are visible from above and threaded into the door 260, whereas in other embodiments (not shown) a plurality of rivets or welds can be used alternatively.

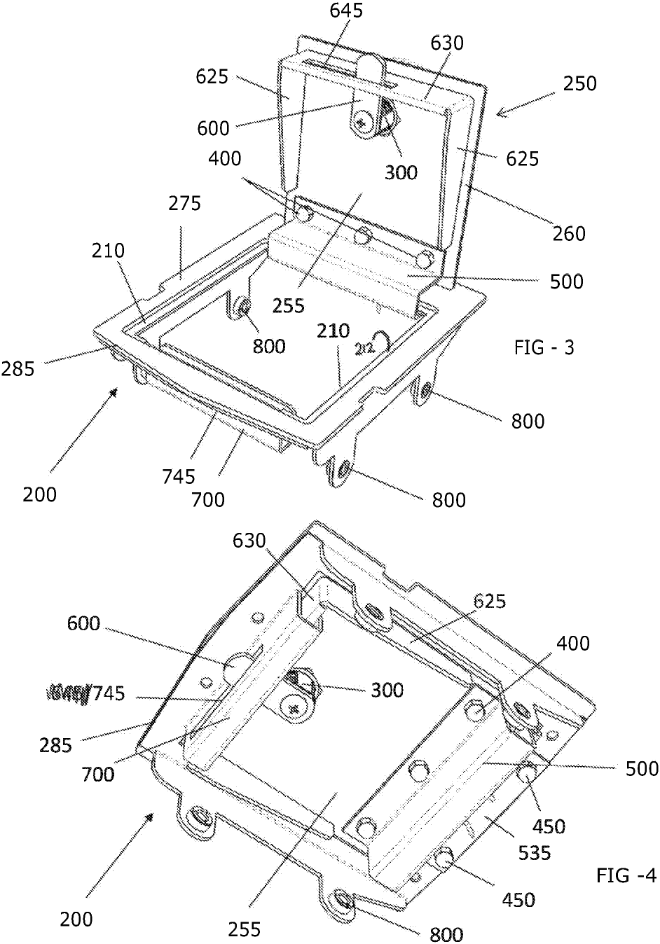

FIG. 3 is a top perspective view of an exemplary door hinge assembly 200 where the door 260 has moved to an open position. The door frame 285 preferably contains a recess 210 sized to accept the perimeter of the door 260. Preferably, the recess 210 is beneath all portions of the gap 280 such that if one looked into the gap 280 one would see the portion of the door frame 285 known as the recess 210. In an exemplary embodiment, the recess 210 is sized just slightly larger than the door 260 in order to accept the perimeter of the door 260 while providing both (1) clearance between the door 260 and the frame 285, (2) complete lack of daylight into the compartment below or between the door 260 and the frame 285. The depth of the recess 210 should be roughly equal to the thickness of the door 260 so that when the door 260 is positioned within the recess 210 (in a closed position), wherein the top surfaces (see 250 in connection with FIG. 2) and 275 of the door and the frame respectively are roughly aligned or sit in the same plane. In some embodiments, the recess 210 is defined by a shoulder having a top surface 212 that at least partially covers the bottom side 255 of the door 260 when the door is in the closed position.

A high security gooseneck 500 preferably attaches to the bottom side 255 of the door 260 using threaded fasteners 400, rivets, or welding. A front wall 630 preferably extends downwardly from the bottom surface 255 of the door and is connected with two sidewalls 625 also extending downwardly from the bottom surface 255. A latch slot 645 extends along the front wall 630 and is sized to accept a portion (distal end) of the latch 600 when the lock 300 rotates into a locked position. A U-shaped latch channel 700 extends downwardly from the bottom surface of the door frame 285 and contains a pair of latch slots 745.

FIG. 4 is a bottom perspective view of an exemplary door hinge assembly 200 where the door 260 has been closed and the lock 300 has rotated the latch 600 into a locked position. When in this position, the latch 600 passes through three separate slots: (1) a first slot 745 in the latch channel 700, (2) slot 645 in the front wall 630, and (3) a second slot 746 in the latch channel 700. One or more threaded fasteners 450, rivets, or welds are preferably used to connect a hinge plate 435 with the bottom surface of the door frame 285.

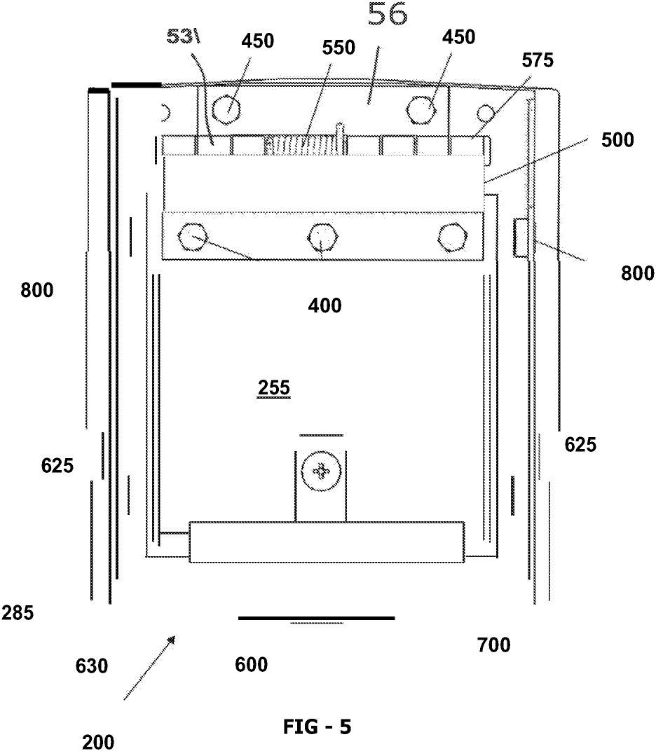

FIG. 5 is a bottom plan view of an exemplary door hinge assembly 200. The gooseneck 500 in this embodiment preferably has a first and second end where the first end connects to a hinge pin 575, and the second end connects to the bottom surface 255 of the door 260 with fasteners 400, rivets, or welding. A spring 550 is positioned at the hinge pin 575 (preferably surrounding at least a portion of the hinge pin 575) and is biased for the door 260 to be normally open. The sidewalls 625 and front wall 630 are shown extending downwardly from the bottom surface 255 of the door 260, and in this depiction the latch 600 is in the locked position, extending through the slots in the front wall and latch channel 700.

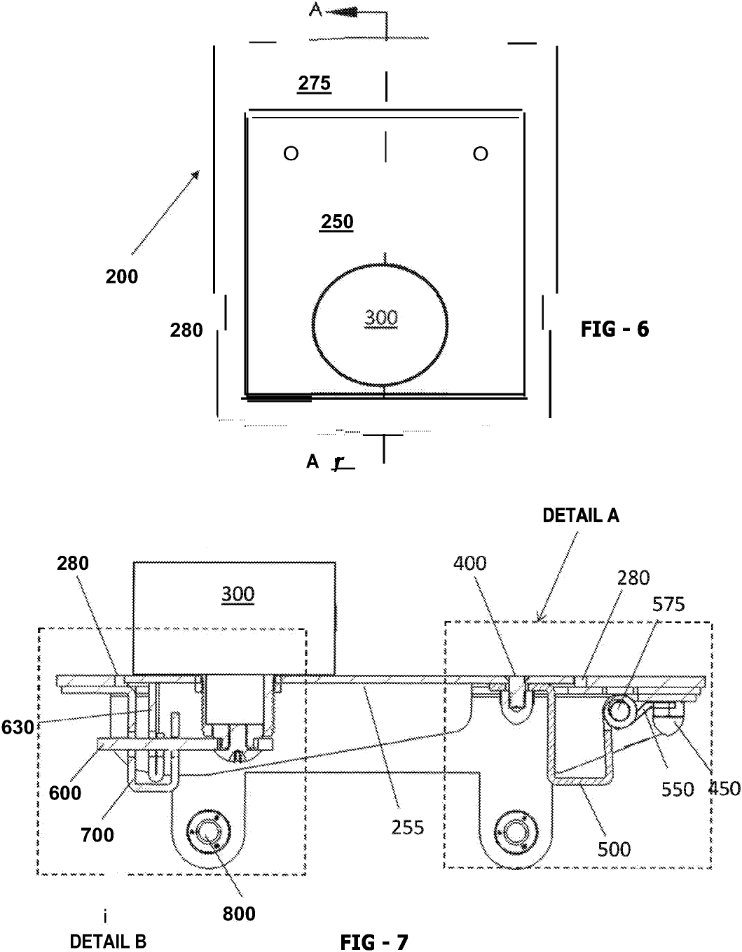

FIG. 6 is a top plan view of an exemplary door hinge assembly 200 and indicating the location of section line A-A. The door gap 280 is visible here, and should generally be provided for such that there is sufficient clearance to permit the door to be readily closed while also minimizing the space into which prying tools can be inserted.

FIG. 7 is a section view taken along section line A-A and indicating the locations of DETAIL A and DETAIL B.

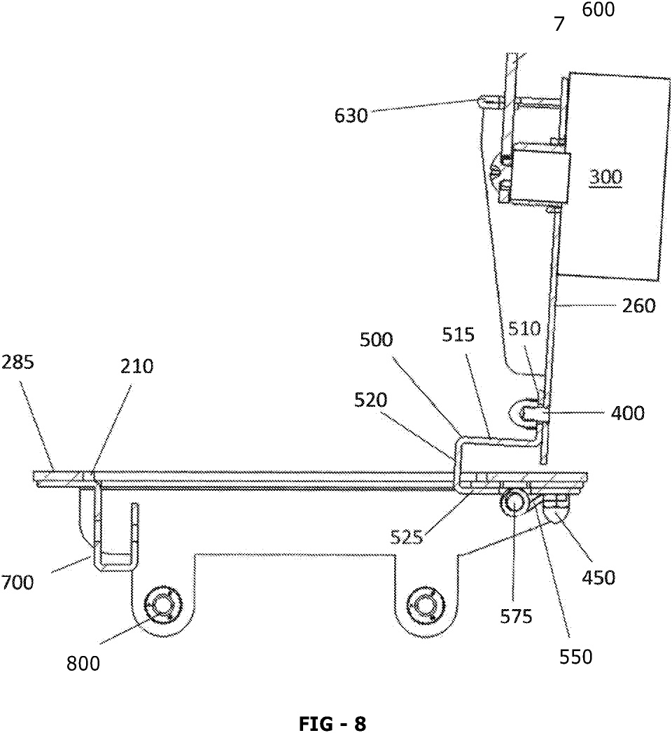

FIG. 8 is a section view taken along section line A-A located in FIG. 6, but wherein the door 260 has been opened. Here the spring 550 is biased to create a rotational force about the axis of the hinge pin 575 to hold the door 260 in this open position normally. The high security gooseneck 500 used here generally comprises a continuous series of elements that will be described further below that form a gooseneck channel between the door and a pivot connection positioned within the compartment and below the door frame. For this purpose, it should be noted that the second wall portion 525 is substantially horizontal here and preferably contacts the bottom of the door frame 285. In this position, the second wall portion 525 is substantially parallel to and in contact with the bottom surface of the door frame 285.

The lower horizontal portion 520 of the gooseneck 500 is generally vertical in this open position, and similarly the first wall portion 515 is generally horizontal and in some embodiments is generally perpendicular to the lower horizontal portion 520. In an exemplary embodiment, the door 260 should be near vertical when in this position or have a slight tilt away from the opening into the compartment through the door frame 285. The U shaped latch channel 700 is shown attached to the underside of the door frame 285.

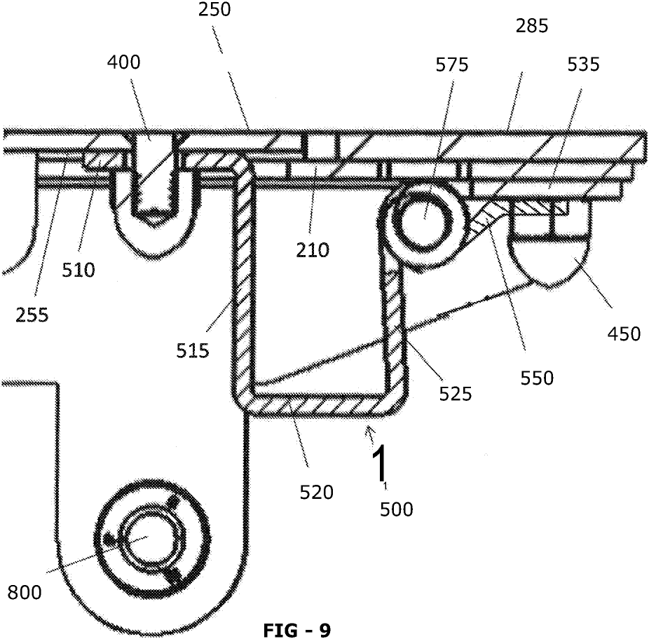

FIG. 9 is a detailed section view of DETAIL A as shown in FIG. 7. The gooseneck 500 in this embodiment is preferably a continuous series of elements. In a preferred embodiment, the continuous series of elements of the gooseneck 500 are at approximately 90 degrees to each other. A flat connecting portion 510 is preferably positioned against the bottom surface 255 of the door and contains aperture(s) 501 for accepting a fastener 400 to attach to both the flat connecting portion 510 and the door 260. The aperture(s) 501 may be threaded, or may be an interference fit with the fastener 400. It should be contemplated that other methods of reversibly or irreversibly attaching the gooseneck 500 to the door 260 may be used without departing from the scope of the present invention. Whatever method of construction used, the door 260 and gooseneck 500 elements should not be separable when the door 260 is in a closed and locked position. A first wall portion 515 may then extend downwardly from the flat portion 510 approximately 90 degrees from horizontal, and then connect to a lower horizontal portion 520 which is preferably positioned at approximately 90 degrees to the first wall portion 515 in this specific embodiment.

This preferred embodiment of the gooseneck 500 then preferably has another 90 degree turn, this time upward and toward the door 260 at approximately 90 degrees from the lower horizontal portion 520. Thus, in this preferred embodiment, the second wall portion 525 is approximately 90 degrees or perpendicular to the lower horizontal portion 520, but this is not required in all embodiments, as explained further below. The second wall portion 525 preferably connects to the hinge pin 575, which is also connected to a hinge plate 535. The hinge plate 535 is preferably attached to the bottom side of the door frame 285 (optionally using fastener 450, but could also be welded or otherwise integrally formed with the door frame). Note that the gooseneck 500 generally has a U-shape with a flat portion 510 for mounting to the door on one side of the U and a hinge pin 575 attached at the other end of the U.

It should be expressly noted that each component of the high security gooseneck 500 may be oriented slightly differently than shown here, specifically with reference to the approximately 90 degree or perpendicular relationships described above. This 90 degree or perpendicular relationship is not required for the invention but may be advantageous for some embodiments. But it should be expressly noted that some embodiments may use a different relationship, specifically for example the angle between the second wall portion 525 and the lower horizontal portion, which could also be anywhere between 60 degrees and 120 degrees, depending on the application. The same variation can be found in the other components such as the flat connecting portion 510, first wall portion 515, lower horizontal portion 520, and second wall portion 525. Further detailed discussion on gooseneck features is provided below.

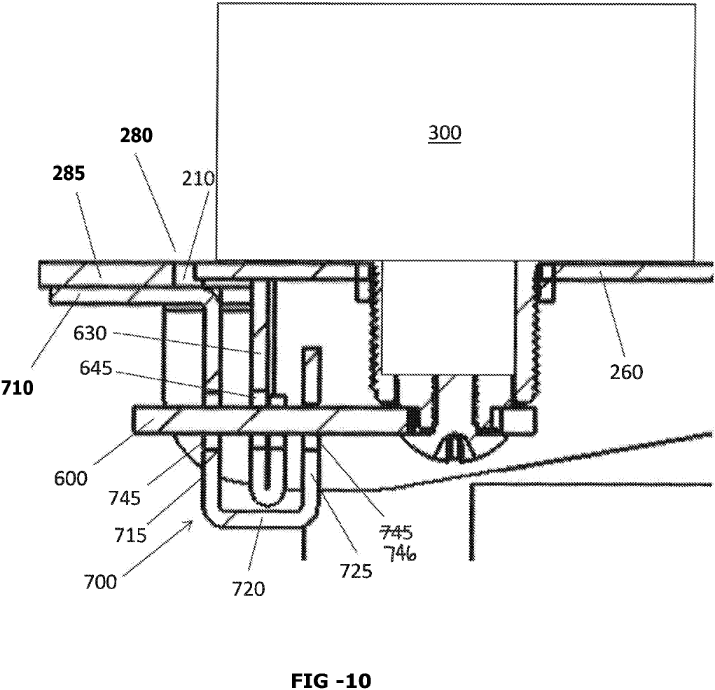

FIG. 10 is a detailed section view of DETAIL B as shown in FIG. 7. Here the various components of the U-shaped latch channel 700 can be observed. An upper horizontal portion 710 is generally flat and is preferably attached to the bottom surface of the door frame 285. In a preferred embodiment, this latch connection location is opposite the door frame from the hinge connection location, but other configurations can be implemented to meet the needs of a particular application without departing from the scope of the invention described herein. A first vertical portion 715 connects to the upper horizontal portion 710 at approximately a 90 degree angle. The channel 700 then turns 90 degrees again to connect with the lower horizontal portion 720 which forms the bottom of the channel 700. A second vertical portion 725 preferably extends up from the lower horizontal portion 720 at approximately a 90 degree angle. Generally, the second vertical portion 725 is preferably parallel to the first vertical portion 715 and perpendicular to the lower horizontal portion 720, but must at least be configured such that the channel 700 can receive within it the front wall 630 of the door 260 when in the closed position. Preferably, the upper horizontal portion 710 is generally parallel to the lower horizontal portion 720.

When in this position, a distal portion of the latch 600 passes through three separate slots: (1) slot 745 in the first vertical portion 715, (2) slot 645 in the front wall 630, and (3) slot 746 in the second vertical portion 725. The door recess 210 of the door frame 285 is preferably positioned beneath every portion of the door gap 280.

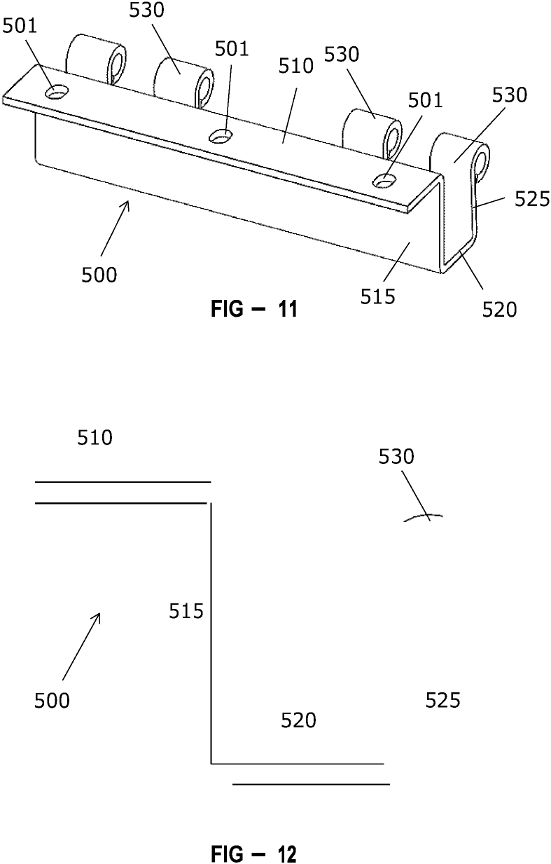

FIG. 11 is a top perspective view of an exemplary embodiment of the high security gooseneck 500. A series of apertures 501 are preferably placed on the connection portion 510 to allow fasteners 400 or rivets to pass through or attach to the connection portion 510. Thus, the apertures 501 could be female threaded holes or simple pass through holes, depending on the application. The second wall portion 525 preferable extends from the lower portion 520 to connect with a plurality of barrels 530 which are sized to accept the hinge pin 575. Similarly, corresponding/complementary barrels 531 are also attached to one edge of the hinge plate 535, also sized to accept the hinge pin 575 (see FIG. 5).

FIG. 12 is a side projection view of the high security gooseneck 500 shown in FIG. 11. In this preferred embodiment, the upper connection portion 510 is approximately the same length as the lower portion 520. Further, the first wall portion 515 is preferably longer than the second wall portion 525. When oriented in this U-shape orientation, the connection portion 510 preferably sits above (vertically higher) than the barrel 530. In this embodiment, the interior angles of the high security gooseneck 500, namely, the first interior angle 516 formed between the first wall portion 515 and the lower portion 520 and the second interior angle 522 formed between the second wall portion 525 and the lower portion 525, are slightly acute.

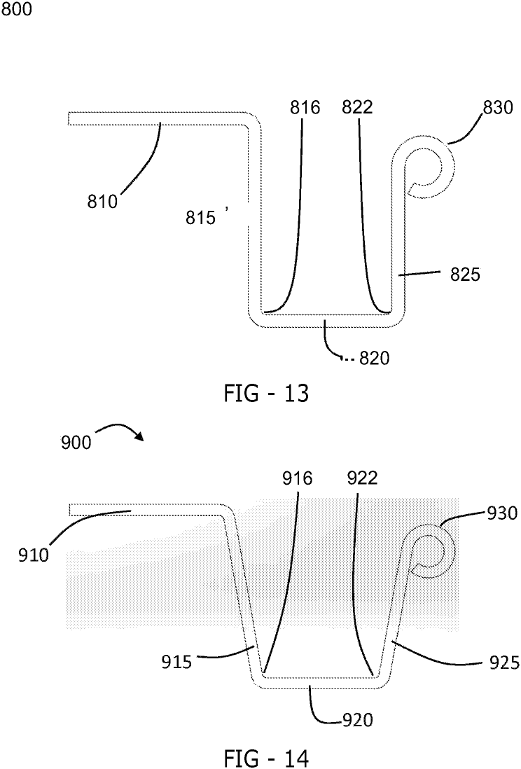

Another embodiment of the high security gooseneck is shown at 800 in connection with FIG. 13. In this embodiment, the connection portion 810, first wall portion 815, lower portion 820 and second wall portion 825 are all perpendicular to each respectively adjacent portion. Therefore, the first 816 and second 822 interior angles are each 90 degrees.

Similarly, a further embodiment of the high security gooseneck is shown at 900 in connection with FIG. 14. In this embodiment, the connection portion 910, first wall portion 915, lower portion 920 and second wall portion 925 are all positioned relative to each respectively adjacent portion such that the first 916 and second 922 interior angles are obtuse.

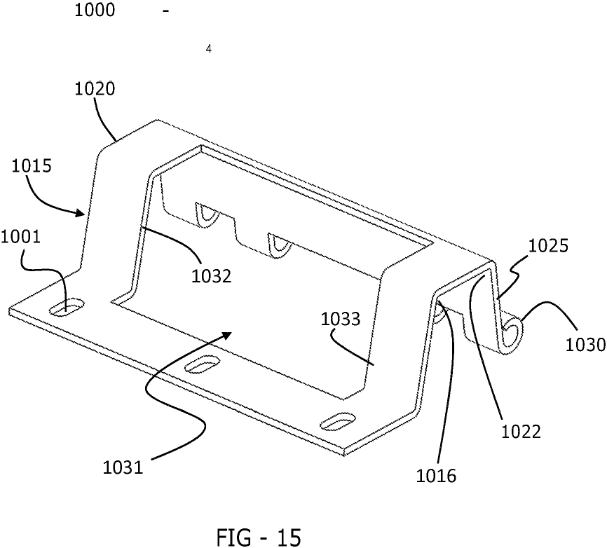

A further embodiment of the high security gooseneck is also shown at 1000 in connection with FIG. 15. In this embodiment, the connection portion 1010, first wall portion 1015, lower portion 1020 and second wall portion 1025 are all also positioned relative to each respectively adjacent portion such that the first 1016 and second 1022 interior angles are obtuse, as in the embodiment shown in connection with FIG. 14. In this embodiment, however, the first wall portion 1015 includes a cutout or void 1031 such that portion 1015 is formed of at least two portions, the first 1032 and second 1033 supports. This may be useful in applications in which clearance or access for a particular purpose are necessary, for instance. Apertures 1001 are visible in this depiction and are similar to those described in connection with FIG. 11 at 501.

The particular combination of features shown herein has surprisingly shown a number of advantages in manufacturing, total weight, assembly time, unit cost, and end-use strength.

The majority of the components herein are preferably metallic or comprised substantially of metal. Some embodiments could utilize plastics or composite materials as an alternative, depending on the application and the target cost for the device.

Having shown and described a preferred embodiment of the invention, those skilled in the art will realize that many variations and modifications may be made to affect the described invention and still be within the scope of the claimed invention. Additionally, many of the elements indicated above may be altered or replaced by different elements which will provide the same result and fall within the spirit of the claimed invention. It is the intention, therefore, to limit the invention only as indicated by the scope of the claim.

All literature and similar material cited in this application, including, but not limited to, patents, patent applications, articles, books, treatises, and web pages, regardless of the format of such literature and similar materials, are expressly incorporated by reference in their entirety. Should one or more of the incorporated references and similar materials differs from or contradicts this application, including but not limited to defined terms, term usage, described techniques, or the like, this application controls.

As previously stated and as used herein, the singular forms “a”, “an”, and “the” refer to both the singular as well as plural, unless the context clearly indicates otherwise. The term “comprising” as used herein is synonymous with “including”, “containing” or “characterized by” and is inclusive or open-ended and does not exclude additional, unrecited elements or method steps. Although many methods and materials similar or equivalent to those described herein can be used, particular suitable methods and materials are described herein. Unless context indicates otherwise, the recitations of numerical ranges by endpoints include all numbers subsumed within that range. Furthermore, references to “one implementation” are not intended to be interpreted as excluding the existence of additional implementations that also incorporate the recited features. Moreover, unless explicitly stated to the contrary, implementations “comprising” or “having” an element or a plurality of elements having a particular property may include additional elements whether or not they have that property.

The terms “substantially” and “about” describe and account for small fluctuations, such as due to variations in processing or operational ranges that are evident from the disclosure to those skilled in the art, for instance. For example, these terms can refer to less than or equal to ±5%, such as less than or equal to ±2%, such as less than or equal to ±1%, such as less than or equal to 0.5%, such as less than or equal to ±0.2%, such as less than or equal to ±0.1%, such as less than or equal to ±0.05%, or 0%.

Underlined or italicized headings and subheadings are used for convenience only, do not limit the disclosed subject matter, and are not referred to in connection with the interpretation of the description of the disclosed subject matter. All structural and functional equivalents to the elements of the various implementations described throughout this disclosure that are known or later come to be known to those of ordinary skill in the art are expressly incorporated herein by reference and intended to be encompassed by the disclosed subject matter. Moreover, nothing disclosed herein is intended to be dedicated to the public regardless of whether such disclosure is explicitly recited in the above description.

There may be many alternate ways to implement the disclosed technology. Various functions and elements described herein may be partitioned differently from those shown without departing from the scope of the disclosed technology. Generic principles defined herein may be applied to other implementations. Different numbers of a given module or unit may be employed, a different type or types of a given module or unit may be employed, a given module or unit may be added, or a given module or unit may be omitted.

Regarding this disclosure, the term “a plurality of” refers to two or more than two. Unless otherwise clearly defined, orientation or positional relations indicated by terms such as “upper” and “lower” are based on the orientation or positional relations as shown in the Figures, only for facilitating description of the disclosed technology and simplifying the description, rather than indicating or implying that the referred devices or elements must be in a particular orientation or constructed or operated in the particular orientation, and therefore they should not be construed as limiting the disclosed technology. The terms “connected”, “mounted”, “fixed”, etc. should be understood in a broad sense. For example, “connected” may be a fixed connection, a detachable connection, or an integral connection, a direct connection, or an indirect connection through an intermediate medium. For an ordinary skilled in the art, the specific meaning of the above terms in the disclosed technology may be understood according to specific circumstances.

It should be appreciated that all combinations of the foregoing concepts and additional concepts discussed in greater detail herein (provided such concepts are not mutually inconsistent) are contemplated as being part of the disclosed technology. In particular, all combinations of claimed subject matter appearing at the end of this disclosure are contemplated as being part of the technology disclosed herein. While the disclosed technology has been illustrated by the description of example implementations, and while the example implementations have been described in certain detail, there is no intention to restrict or in any way limit the scope of the appended claims to such detail. Additional advantages and modifications will readily appear to those skilled in the art. Therefore, the disclosed technology in its broader aspects is not limited to any of the specific details, representative devices and methods, and/or illustrative examples shown and described. Accordingly, departures may be made from such details without departing from the spirit or scope of the general inventive concept.

What is claimed:

1. A door hinge assembly for providing access to a security compartment, comprising:
a door frame comprising:
a top surface;
a recess; and
an interior mounting portion whereby the door hinge assembly is secured to the security compartment;
a door shaped to be received within the recess of the door frame wherein a top surface of the door is coplanar with the top surface of the door frame; and
a gooseneck comprising:
a pivot connection whereby the gooseneck is rotatable about the pivot connection and connected to the door frame;
a connecting portion whereby the gooseneck is fixed to the door; and
a gooseneck channel connecting the pivot connection to the connecting portion.

2. The door hinge assembly of claim 1, wherein the gooseneck channel further comprises:
a first wall portion connected to the connecting portion;
a lower portion connected to the first wall portion at a first interior angle; and
a second wall portion connected to the lower portion at a second interior angle.

3. The door hinge assembly of claim 2, wherein the first and second interior angles are each substantially 90 degrees.

4. The door hinge assembly of claim 2, wherein the first interior angle is between 60 and 120 degrees.

5. The door hinge assembly of claim 2, wherein the second interior angle is between 60 and 120 degrees.

6. The door hinge assembly of claim 1, wherein the pivot connection is positioned below the door frame.

7. The door hinge assembly of claim 1, further comprising:
a latch positioned beneath and rotatable with respect to a bottom surface of the door;
a front wall extending downwardly from the bottom surface of the door having a latch slot wherein the latch is rotatable to extend through the latch slot in the front wall in a locked position; and
a latch channel secured to the door frame into which the front wall is received when the door is rotated about the pivot connection of the gooseneck into a closed position.

8. The door hinge assembly of claim 7, wherein the latch channel further comprises:
an upper portion secured to the door frame;
a first vertical portion connected to the upper portion and having a first latch slot;
a lower portion connected to the first vertical portion; and
a second vertical portion connected to the lower portion and having a second latch slot, wherein the first and second vertical portions and lower portions form a channel into which the front wall of the door is received when the door is rotated about the pivot connection of the gooseneck into a closed position.

9. The door hinge assembly of claim 1, wherein the gooseneck is shaped to receive a portion of the door frame in the gooseneck channel when the door is rotated into an open position.

10. The door hinge assembly of claim 1, wherein the gooseneck comprises:
a connecting portion secured to the door;
a first wall portion connected to the connecting portion;
a lower portion connected to the first wall portion at a first interior angle;
a second wall portion connected to the lower portion at a second interior angle; and
a pivot connection connecting the second wall portion to the door frame whereby the gooseneck is rotatable about the pivot connection with respect to the door frame.

11. The door hinge assembly of claim 1, wherein the interior mounting portion comprises:
at least one mounting tab extending downwardly from the door frame; and
at least one mounting aperture on the at least one mounting tab, whereby the door frame is fixable to the security compartment.

12. A door hinge assembly for providing access to a security compartment, comprising:
a door comprising:
a top surface;
a bottom surface;
a latch positioned beneath and rotatable with respect to the bottom surface of the door; and
a front wall extending downwardly from the bottom surface of the door having a latch slot wherein the latch is rotatable to extend through the latch slot in the front wall in a locked position;
a door frame comprising an interior mounting portion whereby the door hinge assembly is secured to the security compartment;
a gooseneck comprising:
a connecting portion secured to the bottom surface of the door;
a first wall portion connected to the connecting portion;
a lower portion connected to the first wall portion at a first interior angle;
a second wall portion connected to the lower portion at a second interior angle; and
a first hinge barrel set comprising at least one hinge barrel connected to the second wall portion;
a hinge plate fixed to the door frame and having a second hinge barrel set comprising at least one hinge barrel complementarily formed with respect to the first hinge barrel set of the gooseneck;
a hinge pin connecting the first and second hinge barrel sets whereby a pivot connection is formed between the gooseneck and the hinge plate; and
a latch channel secured to the door frame comprising:
an upper portion secured to the door frame;
a first vertical portion connected to the upper portion;
a lower portion connected to the first vertical portion; and
a second vertical portion connected to the lower portion, wherein the first and second vertical portions and lower portions form a channel into which the front wall of the door is received when the door is rotated about the pivot connection of the gooseneck into a closed position.

13. The door hinge assembly of claim 12, wherein the first and second interior angles are each substantially 90 degrees.

14. The door hinge assembly of claim 12, wherein the first interior angle is between 60 and 120 degrees.

15. The door hinge assembly of claim 12, wherein the second interior angle is between 60 and 120 degrees.

16. The door hinge assembly of claim 12, wherein the interior mounting portion comprises:
at least one mounting tab extending downwardly from the door frame; and
at least one mounting aperture on the at least one mounting tab, whereby the door frame is fixable to the security compartment.

17. The door hinge assembly of claim 12, wherein the first wall portion of the gooseneck further comprises a cutout.
